(19) United States
(12) Patent Application Publication
(10) Pub. No.: US 2010/0258519 A1
(43) Pub. Date: Oct. 14, 2010

(54) Infant Feeding Pouch

(76) Inventor: Qwentella Shawnell Shelby, Rock Hill, SC (US)

Correspondence Address: WHITE-WELKER & WELKER, LLC, P.O. BOX 199, CLEAR SPRING, MD, 21722-0199, US

(21) Appl. No.: 12/779,936

(22) Filed: May 13, 2010

Related U.S. Application Data
(63) Continuation-in-part of application No. 12/107,284, filed on Apr. 22, 2008, now abandoned.

(51) Int. Cl. A61J 9/00; A45F 3/16

(52) U.S. Cl. 215/11.3; 224/148.1

(57) ABSTRACT

The present invention is an infant feeding pouch that is a transparent low-density polyethylene or polypropylene bag. The pouch has two sections, and a middle section. The middle section of the pouch is collapsible. The middle oval section is able to contain 8 to 9 ounces of fluid. As the fluid enters the middle section it enlarges. As the fluid exits the pouch it collapses. The middle section of the feeder has an opening; it is here were the fluid is deposited. The opening is located in the center of the middle section at the bottom. The middle section has a non-removable threaded fitting welded onto the pouch enabling the toppro to be attached. The toppro is a bottle cap with screwable threads in the interior.

### CROSS REFERENCE TO RELATED APPLICATIONS:

This application is a continuation in part of U.S. patent application Ser. No. 12/107,284, entitled “Infant Feeding Pouch”, filed on 22 Apr. 2008. The benefit under 35 USC §119(e) of the United States provisional application is hereby claimed, and the aforementioned application is hereby incorporated herein by reference.

This application is related to U.S. Provisional Patent Application Ser. No. 60/874,259, entitled “Paternal Infant Feeding Pouch”, filed on Dec. 12, 2006.

### FEDERALLY SPONSORED RESEARCH

Not Applicable

### SEQUENCE LISTING OR PROGRAM

Not Applicable

### TECHNICAL FIELD OF THE INVENTION

The present invention relates generally to an infant feeding device. More specifically, the present invention relates to an infant feeding pouch that provides bonding means through artificial breastfeeding.

### BACKGROUND OF THE INVENTION

The responsibilities regarding breastfeeding lie exclusively on the maternal parent. These issues have not been addressed in today's society and the prior art. The problems with existing products and those taught in the prior art include the anatomy of the devices taught, the lack of paternal influence, the inability to dispose, and the inaccessibility linked with traveling.

Some have offered devices in an attempt to overcome the aforementioned shortcomings, but all have failed for various reasons discussed below. For example, U.S. Pat. No. 4,776,546 teaches a bib-like device for assisting in nursing a child and improving bonding between a parent and the child. The device includes a bib-like member made from a fabric, such as terry cloth, comfortable for the child. The device defined includes a generally mammary-shaped area defining a pouch therein for retaining a container of liquid, such as formula, milk, juice, or water for the child. The pouch is sized to receive the container therein and communicates with an opening in the fabric for permitting a nipple on the container to protrude therefrom. When worn by either parent, the device improves bonding between the child and parent, especially for the male, by anatomically simulating the female.

U.S. Pat. No. 5,582,335 teaches a nursing baby bottle holder for supporting a baby bottle in a nursing position is provided. The baby bottle has a body portion and a neck portion. The holder comprises a length of material defining an annular open end to releasably secure the body portion of the baby bottle. The length is sufficient to drape the material around a neck of a user while supporting the baby bottle in a nursing position.

U.S. Pat. No. 6,669,064 teaches a bonding nurser that can be used to closely approximate breast feeding mechanically and psychologically comprises a feeding container that simulates a breast in fluid delivery, shape, texture, feel, and ease of infant suckling releasably attached to a sling so that the container is positioned on the breast area of the adult feeding the baby, and the adult's hands are free for cuddling the baby during feeding. The feeding container is a breast-shaped flexible housing that holds a collapsible bag which delivers milk or other fluids through a nipple protruding through the apex of the housing and is filled through a screw cap opening at the base opposite the apex and secured in the housing by retaining straps surfaced with Velcro. When the container is assembled, i.e., a bag is positioned in the housing, the straps present a loop interface that mechanically couples the base of the container to a correspondingly sized hook-surfaced area on a shoulder strap (or a hand strap).

What is needed is an infant feeding pouch that includes proper anatomy, is easily disposed, sterile, and safe. Conventional devices known in the prior art as discussed above consist primarily of a pouch and nipple, or means for holding a standard bottle. The pouch devices do not have the feeling of a female breast and the pouch, if part of the device, Additionally, a pouch has to be mounted on shirt within carrier, and the contents in pouch may not be emptied in one feeding and no means for storing milk is provided.

Therefore, it is an objective of the present invention to teach an infant feeding pouch that overcomes these disadvantages.

### SUMMARY OF THE INVENTION

The present invention is an infant feeding pouch that is a transparent low-density polyethylene or polypropylene bag held within carrier. The pouch is collapsible. The middle oval section is able to contain 8 to 9 ounces of fluid. As the fluid enters the middle section it enlarges. As the fluid exits the pouch it collapses. The middle section of the feeder has an opening, it is here were the fluid is deposited.

The opening is located in the center of the middle section at the bottom. The middle section has a non-removable threaded fitting welded onto the pouch enabling the toppro to be attached. The toppro is a bottle cap with screwable threads in the interior.

The pouch of the present invention provides a nipple that protrudes making it easier for the infant to latch on the feeding pouch. The infant feeding pouch of the present invention can also be filled with ready-to-feed milk and milk warmed by body heat.

The pouch of the present invention is used in combination with a carrier. The carrier, in combination with the infant feeding pouch 1, allows a wearer to hold a baby close to their chest and frees up their hands from holding the bottle and allows them to focus on holding and caressing the baby and focus on the most important part, bonding with the baby. There is a storage area that can hold wipes, diapers, pacifiers, and small milk containers and other essentials when not in use holding the bottle, which eliminates the need for a separate or secondary bag. Any family member can use the device, not just the mother.

Simply remove infant feeding pouch 1 from carrier 4 by opening the zipper to access the storage area, remove the nipple and cap, and insert a liner into the infant feeding pouch 1. Then insert the infant feeding pouch 1 in the carrier making sure the nipple protrudes through the opening in the carrier. Adjust the straps for fit and the device is ready for use. The straps can be adjusted for the cradle, Taylor and football positions. The straps can be adjusted until there is a comfortable fit for the wearer. When finished, the wearer may simple close the flap that is hinged on the outside of the carrier, which can be secure by hook and loop fasteners, magnets, or other securing means known in the art to cover the nipple for later use.

The carrier has two shoulder straps, which are connect to opposing sides of the storage area. One strap is provided with a double adjustable side release buckle that can be quickly disconnected to remove the carrier and also provides a means for adjustability. The other strap may or may not be equipped with a buckle, and if no buckle is present, an adjuster is provided so that each strap is comprised of an adjusting means. Additionally, the strap system is built with symmetry along its centerline so that it can be easily worn over the left or right shoulders. The carrier can also be worn as a backpack when not in use.

Yet another advantage of the present invention is that the infant feeding pouch is hands-free, strapless, and collapsible that enables an infant to mimic breastfeeding with parent.

Another advantage of the present invention is that the pouch collapses and pushes the fluid from the nipple eliminating air in the pouch and infant's stomach. Additionally, the pouch is BPA free and pre-sterilized for safety.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is an exploded view of the infant feeding pouch of the present invention;

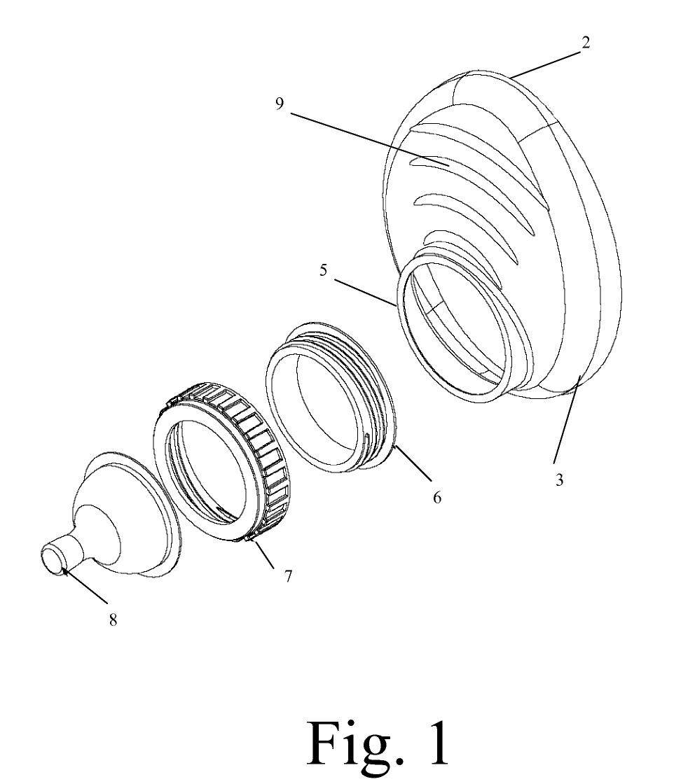

FIG. 2 illustrates a perspective view of the infant feeding pouch of the present invention;

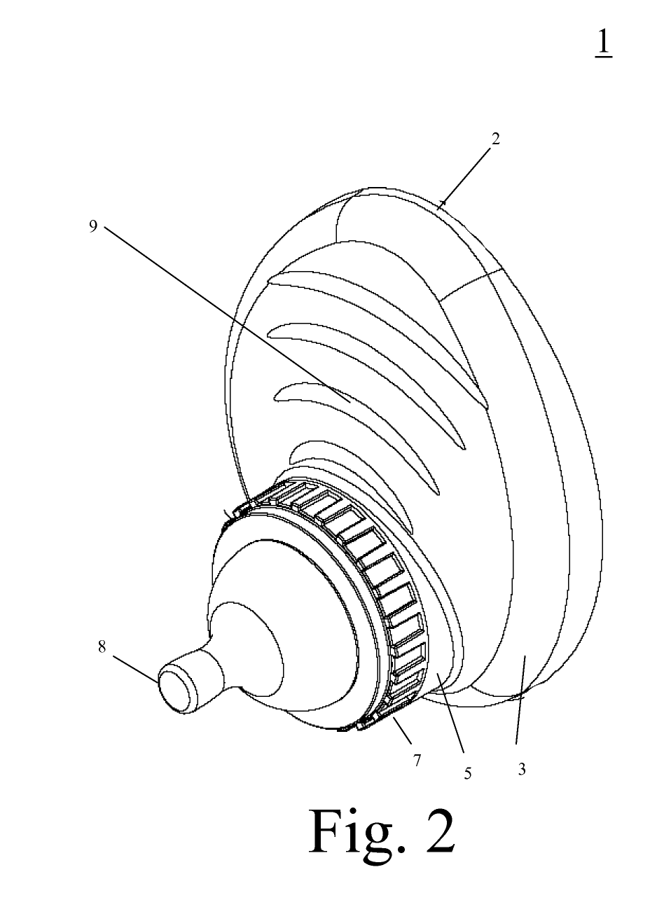

FIG. 3 is a side plan view of the infant feeding pouch of the present invention;

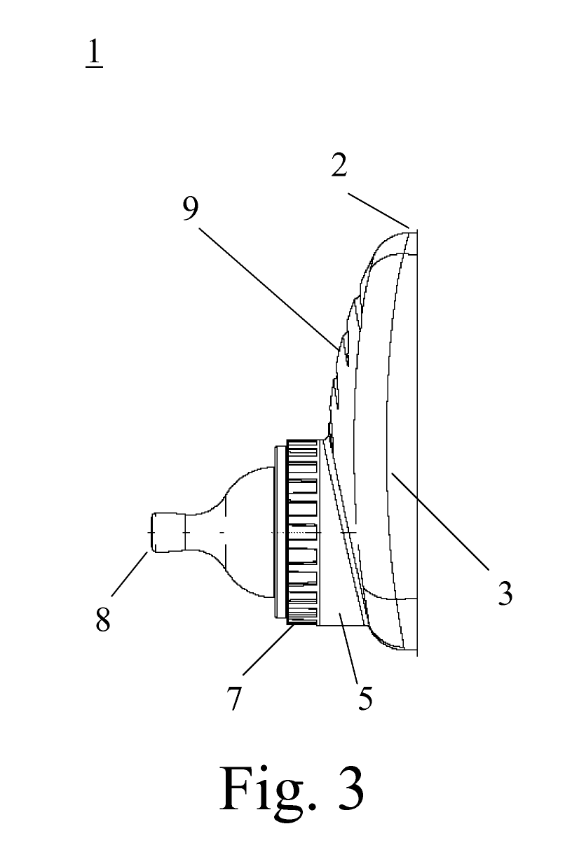

FIG. 4 is a cut away view of the infant feeding pouch of the present invention;

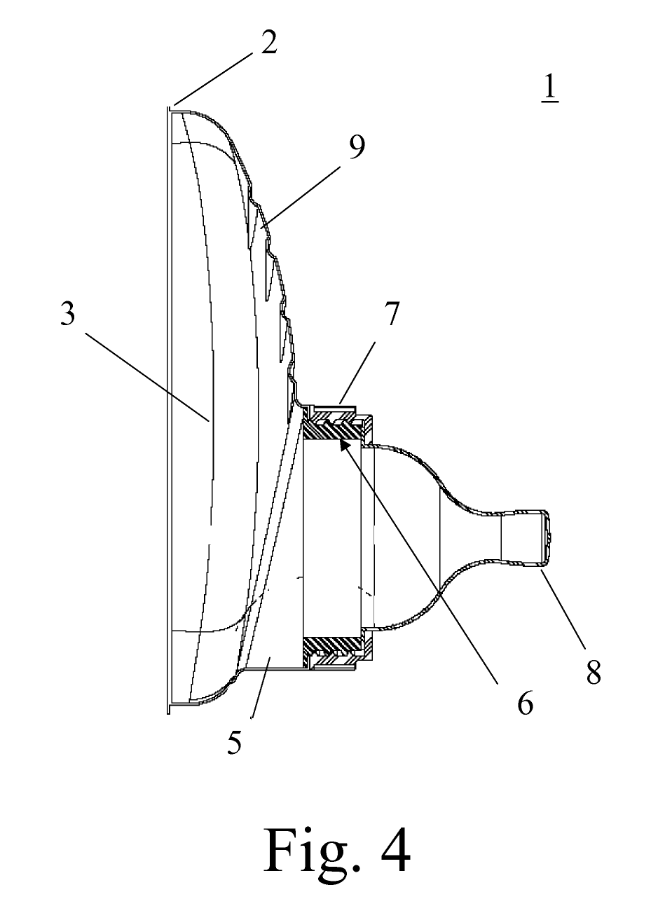

FIG. 5 is a front perspective view of the strap system retaining an infant feeding pouch while being worn by a user; and

FIG. 6 is a back perspective view of the strap system retaining an infant feeding pouch while being worn by a user.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Referring to the figures, it is possible to see the various major elements constituting the apparatus of the present invention. The present invention is an infant feeding pouch. The infant feeding pouch of the present invention is used to assist with breastfeeding an infant. An infant that is breastfed can use the feeding pouch when the mother is not available. The pouch also allows adoptive mothers, spouses, and grandparents to help with the breastfeeding responsibilities. The feeding pouch is not shaped like a breast so it will not alienate the spouse. The pouch is BPA-free contains and no polycarbonate material. The pouch also allows mothers who have undergone a caesarian to position the infant easier. The pouch provides bonding between both parents. Most bottles allow for the paternal parent to feed baby but do not provide for a bonding experience equal to that reported by breastfeeding parents. It is also accessible when traveling to open places to feed like malls, restaurants, and family outings.

Now referring to the Figures, the infant feeding pouch 1 is comprised of a transparent low-density polyethylene or polypropylene pouch 2. The low-density polyethylene pouch 2 has a middle section 3. The middle section 3 of the pouch 2 is collapsible. The middle section 3 is oval in shape and is able to contain 8 to 9 ounces of fluid. As the fluid enters the middle section 3 it enlarges by expanding the low density polyethylene or poly propylene material against its inherent elasticity and the expansion portions 9 located on the anterior surface of the middle section 3. As the fluid exits the middle section 3 it collapses the expansion portions 9 located on the anterior surface of the middle section 3 returns to their resting state due to the elasticity of the low-density polyethylene or polypropylene material from which the pouch 2 is made.

The middle section 3 of the infant feeding pouch 1 has an opening support 5 providing means for connecting a fitting 6 to the pouch 1 via the opening support 5 which on its anterior surface that is typically circular in shape and it is here where the fluid is deposited into the middle section 3. The opening support 5 is located in on the bottom center of the anterior surface of the middle section 3 and provides attachment means for the nipple in a manner where the nipple opening is perpendicular to the anterior surface of the middle section 3. The middle section 3 has a non-removable fitting 6 welded onto the opening support 5 located on the middle section 3. The fitting 6 has threads on its exterior. The fitting has screwable threads enabling a toppro 7 to be attached. The toppro 7 is made like a bottle cap with screwable threads in its interior and provides securing means to retain a nipple 8.

The detachable nipple 8 is located inside a plastic cap, referred to as a toppro 7, when not in use. The detachable nipple 8 is made form silicon and is reusable. The toppro 7 is made of plastic and has an opening to attach the silicon nipple. The detachable nipple 8 has the anatomy of a protruding human nipple. The detachable nipple 8 may have a hook shape at the tip of the nipple. The toppro 7 has screwable grooves located in its interior. The detachable nipple 8 has a hole located at the tip of the nipple to extract fluid. The detachable nipple 8 and toppro 7 are located in the front of the infant feeding pouch. The pouch takes the shape of a bumblebee or half moon.

The method for manufacturing the infant feeding pouch starts with extruding blown films sheets. Next, two sheets are cut to a desired shape and heat-sealed. The two sheets are made of LLDPE back film and heat-sealed. The front film is retrofitted with the toppro and nipple assembly. The nipple is made of heat-resistant silicon.

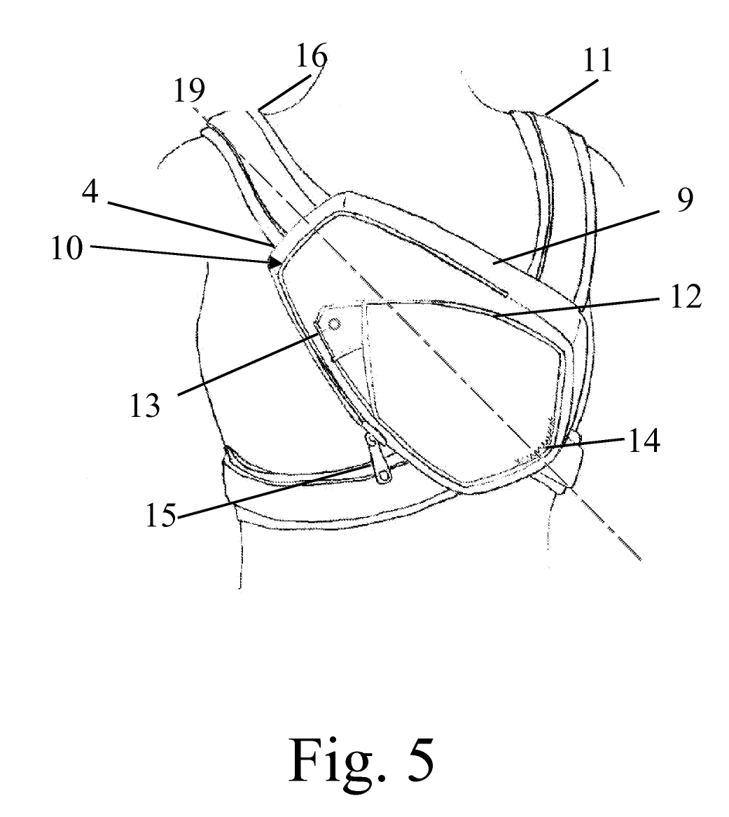

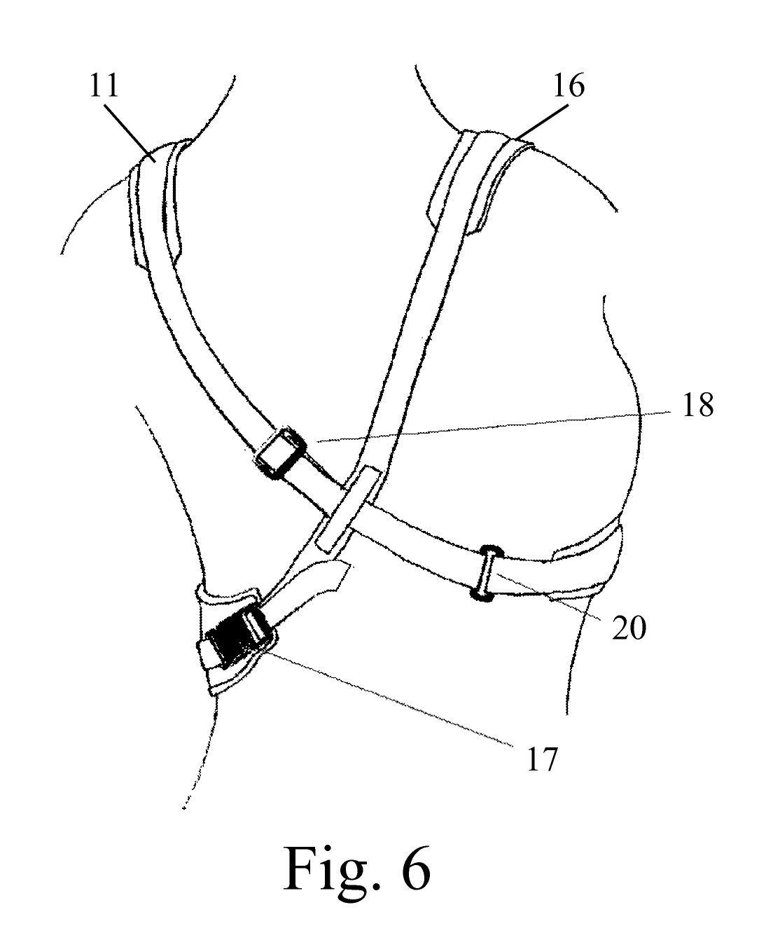

Now referring to FIGS. 5-6, the carrier 4, in combination with the infant feeding pouch 1, allows a wearer to hold a baby close to their chest and frees up their hands from holding the infant feeding pouch 1 and allows them to focus on holding and caressing the baby and focus on the most important part, bonding with the baby. There is a storage area 5 that can hold wipes, diapers, pacifiers, and small milk containers and other essentials when not in use holding the infant feeding pouch 1, which eliminates the need for a separate or secondary bag. Any family member can use the device, not just the mother.

Simply remove infant feeding pouch 1 from carrier 4 by opening the zipper 15 to access the storage area 9, remove the nipple 8 and cap 7, and insert a liner into the infant feeding pouch 1. Then insert the infant feeding pouch 1 in the carrier 4 making sure the nipple 8 protrudes through the opening 10 in the carrier 4. Adjust the straps 11 and 16 for fit and the device is ready for use. The straps 11 and 16 can be adjusted for the cradle, Taylor and football positions. The straps 11 and 16 can be adjusted until there is a comfortable fit for the wearer. When finished, the wearer may simple close the flap 12 that is hinged 14 on the outside of the carrier 4, which can be secure by hook and loop fasteners, magnets, or other securing means known in the art 13 to cover the nipple 8 for later use.

The carrier 5 has two shoulder straps 11 and 16 that are connect to opposing sides of the storage area 9. One strap is provided with a double adjustable side release buckle 17 that can be quickly disconnected to remove the carrier 5 and also provides a means for adjustability. The other strap may or may not be equipped with a buckle, and if no buckle is present, an adjuster 18 and connector 20 to attached the strap to one end of the storage area 9 is provided so that each strap is comprised of an adjusting means. Additionally, the strap system is built with symmetry along its centerline 19 with respect to the storage area 9 so that it can be easily worn over the left or right shoulders. The carrier 5 can also be worn as a backpack when not in use.

In an alternative manufacturing method 2-¼″ 12-undoubled start thread is used with BOPP films (food grade). The film is cut using die cutting technology and the edges are sealed with heat and 0.25″ seaming. In this manufacturing process, the wings would be injection molded and welded on.

In yet another alternative manufacturing method, the pouch is blow molded with the wings injection molded and later heat-sealed.

In all manufacturing processes, the threads are spiral and inclined, while the fitting and toppro parts are injection molded with the fitting heat sealed on the pouch.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. An infant feeding pouch in combination with a carrier comprising:
a pouch consisting of a middle section providing means for retaining a fluid;
said middle section is comprised of
an opening support on a first anterior surface that provides means for a fluid to be deposited into the middle section;
a non-removable fitting secured to the opening support located on the middle section;
the fitting comprised of an exterior threaded surface providing attachment means;
a toppro comprised of a threaded interior surface providing attachment and securing means to the threaded exterior surface of said fitting;
the toppro further comprised of securing means for securing said nipple a nipple;
a carrier for holding the feeding pouch in a combination, the pouch consisting of;
a storage area for retaining the feeding pouch;
a closure means for opening an closing the storage area;
an opening in the storage area providing a means for protrusion of the nipple from the storage area;
a flap for covering the opening in the storage area;
adjustable straps for securing the combination to a wearer; and
the adjustable straps are connected to the storage area symmetrically along the storage area's centerline with respect to the storage area so that it can be easily worn over the left or right shoulders.

2. The feeding pouch of claim 1, wherein the closing means for the storage area is a zipper.

3. The feeding pouch of claim 1, wherein the closing means for the storage area is a hook and loop fastener.

4. The feeding pouch of claim 1, wherein the closing means for the storage area is magnetic.

5. The feeding pouch of claim 1, wherein the closing means for the flag is magnetic.

6. The feeding pouch of claim 1, wherein the closing means for the flap is a hook and loop fastener.

7. The feeding pouch of claim 1, wherein the straps can be adjusted for the cradle, Taylor and football positions.

8. The feeding pouch of claim 1, wherein at least one strap is provided with a double adjustable side release buckle.

9. The feeding pouch of claim 8, wherein the other strap is provided with an adjuster.

10. The feeding pouch of claim 1, wherein the pouch is made from transparent low-density polyethylene or polypropylene.

11. The feeding pouch of claim 1, wherein pouch has two sections and a middle section.

12. The feeding pouch of claim 1, wherein the middle section is oval in shape and is able to contain 8 to 9 ounces of fluid.

13. The feeding pouch of claim 1, wherein the opening support on the first anterior surface of the middle section is circular in shape.

14. The feeding pouch of claim 14, wherein the opening support is located on the bottom center of the anterior surface of the middle section.

15. The feeding pouch of claim 1, wherein
as the fluid enters the middle section it enlarges by expanding against the inherent elasticity of the material from which the middle section is made; and
as the fluid exits, the middle section returns to its resting state due to the inherent elasticity of the material from which the middle section is made.

16. The feeding pouch of claim 1, wherein the anterior surface of the middle section is further comprised of expansion means so that
as the fluid enters the middle section it expands the expansion portions located on the anterior surface of the middle section to accommodate the fluid; and
as the fluid exits the middle section it collapses the expansion portions located on the anterior surface of the middle section and returns them to their resting position.
